(19) United States
(12) Patent Application Publication
(10) Pub. No.: US 2005/0028665 A1
(43) Pub. Date: Feb. 10, 2005

(54) Method of improving repetitive striking performance, jack and action mechanism of piano

(76) Inventor: Kousuke Tanaka, Hamamatsu-shi (JP)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/900,550

(22) Filed: Jul. 28, 2004

(30) Foreign Application Priority Data
Aug. 4, 2003 (JP) 2003-286045

(51) Int. Cl. G10C 3/18

(52) U.S. Cl. 84/236

(57) ABSTRACT

A jack used in an action mechanism of a piano has substantially an L-shape, composed of a big jack portion and a small jack portion. The thickness of the small jack portion is made smaller than that of the big jack portion in a direction of key arrangement in a state of the jack being fitted in the piano. By reducing the weight of the small jack portion as above, the time required for the jack to return to a position capable of pushing up a part of a striking member can be shortened. Accordingly, more frequent repetitive striking is allowed within a predetermined period.

### BACKGROUND OF THE INVENTION

i) Technical Field of the Invention

This invention relates to a technique of improving repeated striking performance of a piano.

ii) Description of the Related Art

A piano is conventionally provided with a known action mechanism that operates in response to key depression and makes a striking member strike a string, as disclosed in Unexamined Japanese Patent Publication No. 9-281959, for example.

Also, as can be seen in Unexamined Japanese Utility Publication No. 49-919, the action mechanism comprises a substantially L-shaped jack composed of elongated portions, specifically, a big jack portion and a small jack portion. The small jack portion is arranged almost perpendicular to the big jack portion. The thickness of the big jack portion and the small jack portion is nearly constant in the direction of key arrangement in a state of the jack being fitted in the piano.

In the action mechanism as above, the jack is raised in response to key depression and pushes up a shank roller, that is, a part of the striking member, with the apex of the big jack portion. Furthermore, when the free end of the small jack portion abuts on a regulating button, the jack is rotated and the apex of the big jack portion is separated from the shank roller. Then, the striking member, which was pushed up by the jack, swings to a string side to strike a string.

### SUMMARY OF THE INVENTION

In this type of action mechanism of a piano, when a player stops depressing a key and therefore releases the key, the jack, in a state of having pushed up the shank roller, is returned in a reset direction (that is, a direction toward the original position where the jack had been located prior to the key depression) by the spring force of a repetition spring. As the jack is returned to a position (hereinafter, referred to as a push-up capable position) capable of again pushing up the striking member which has struck a string and returned, the jack is ready for the next striking of the string (a repeated striking). Accordingly, if the time required for the jack to return to the push-up capable position is made shorter, greater number of times of repeated striking can be exercised within a predetermined period.

However, the spring force of the repetition spring has limits to shortening the aforementioned time. Consequently, the conventional action mechanism is also limited in improving repetitive striking performance. This results in a failure to fully comply with the demands for high-speed repetitive striking from players having advanced playing skills. Here, the action mechanism of a grand piano is taken as an example. However, the same problem exists in the action mechanism of an upright piano.

One object of the present invention, which was made to solve the above problem, is to improve the repeated striking performance of a piano.

In order to attain the above object, one aspect of the present invention provides a method of improving the repeated striking performance of a piano comprising an action mechanism in which a substantially L-shaped jack pushes up a part of a striking member in response to a key depression in order to make the striking member strike a string.

The jack is composed of elongated jack portions, that is, a big jack portion that pushes up the striking member and a small jack portion arranged almost perpendicular to the big jack portion. Specifically, the weight of the small jack portion is reduced as compared to conventional designs, resulting in a lightened small jack portion.

According to such a method of improving the repeated striking performance, the rotational speed of the jack, when a spring force toward a reset direction is applied to the jack, is increased due to the reduction in weight of the small jack portion. As a result, the time required for the jack to return from a position where the jack has pushed up a part of the striking member (that is, a position immediately after striking a string) to a position capable of pushing up the part again (a push-up capable position) can be shortened.

Furthermore, in this case, only the weight of the small jack portion, rather than the weight of the jack as a whole, is trimmed. Therefore, sufficient strength for moving the striking member is maintained while achieving an improvement in the repeated striking property.

Another aspect of the present invention provides a jack to be used in an action mechanism of a piano. The jack is formed into substantially an L-shape and pushes up a part of a striking member in response to a key depression in order to make the striking member strike a string.

The jack is composed of an elongated big jack portion that pushes up a part of the striking member and a lightened small jack portion arranged almost perpendicular to the big jack portion. Particularly, the thickness of the lightened small jack portion is made thinner than the thickness of the big jack portion in a direction of key arrangement in a state of the jack being fitted in the piano.

In the above jack, the weight of the lightened small jack portion is reduced by making the thickness of the lightened small jack portion less than the thickness of the big jack portion (lightening).

If such a jack is used in the action mechanism of a piano, the rotational speed of the jack, when a spring force toward a reset direction is applied to the jack, can be increased, as already mentioned above. Accordingly, shortening the time is possible for the jack to return from a position where the jack has pushed up the part of the striking member to the push-up capable position. Moreover, only the weight of the small jack portion is trimmed rather than the weight of the jack as a whole. Therefore, sufficient strength for moving the striking member is maintained while achieving an improvement in the repeated striking property.

Further, another aspect of the present invention provides an action mechanism of a piano comprising a substantially L-shaped jack that pushes up a part of a striking member in response to key depression to make the striking member strike a string. Specifically, the jack described as above is used.

As a result, while the jack maintains sufficient strength for moving the striking member, it is possible to improve the repeated striking property of the piano.

### BRIEF DESCRIPTION OF THE DRAWINGS

The invention will now be described by way of example, with reference to the accompanying drawings in which:

FIG. 1 is a view showing an action mechanism of a piano according to an embodiment of the present invention;

FIGS. 2A-2C are explanatory views illustrating a difference in shapes between a jack used in the action mechanism of the present embodiment and a conventional jack; and

FIG. 3A is a view of a jack used in experiments for ascertaining the effects of the present embodiment and FIG. 3B is a graph showing the results of the experiments.

FIGS. 4A-4C are views illustrating variations of a lightened small jack portion.

### DETAILED DESCRIPTION OF PREFERRED EMBODIMENT

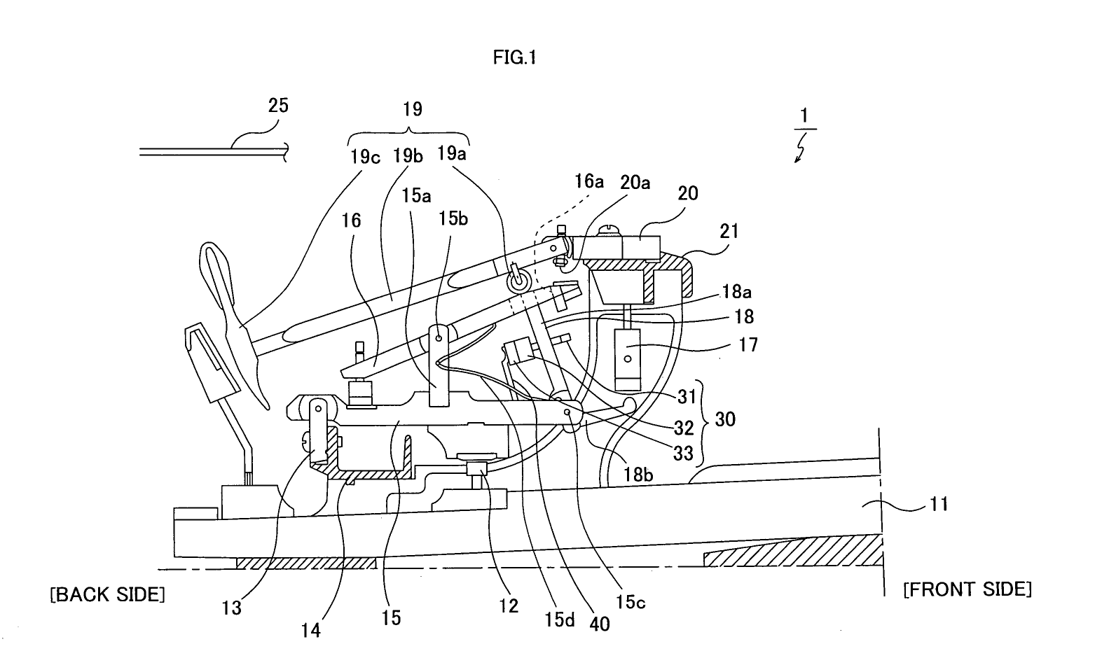

FIG. 1 shows an action mechanism 1 of a piano of the present embodiment. In the following description of the action mechanism 1, a player side (right side in FIG. 1) is referred to as a front side, and the side opposite to the player side (left side in FIG. 1) is referred to as a back side. Also, directions of up and down in the following description correspond to those in FIG. 1, if not mentioned explicitly.

This action mechanism 1 comprises a capstan screw 12 that is raised when a key 11 is depressed by the operation of a player, a wippen 15 that is rotatably supported by a wippen rail 14 via a wippen flange 13 and swings upward by the rising of the capstan screw 12, a repetition lever 16 that is rotationally supported by a rotational shaft 15b provided at a top end of a support 15a on the wippen 15 and raised together with the wippen 15, a jack 18 that is rotatably connected to a rotational shaft 15c provided at an end of the wippen 15 and raised together with the wippen 15 until abutting on a regulating button 17, and a striking member 19 that is pushed up by the rising of the jack 18 so as to strike a string, etc. The striking member 19 is composed of a shank roller 19a that is pushed up by an apex (in more detail, the apex of a later-explained big jack portion 18a) of the jack 18 which passes through a long hole 16a provided in a tip portion of the repetition lever 16, a hammer shank 19b that is rotatably supported by a shank rail 21 via a shank flange 20 and swings upward when the shank roller 19a is pushed up, and a hammer head 19c that is attached to an end of the hammer shank 19b and moves upward by the swinging of the hammer shank 19b so as to strike a string 25.

Furthermore, the wippen 15 is provided with a repetition spring 15b which provides a resetting force to the repetition lever 16 and the jack 18 for returning them to their original positions where they were located before key depression.

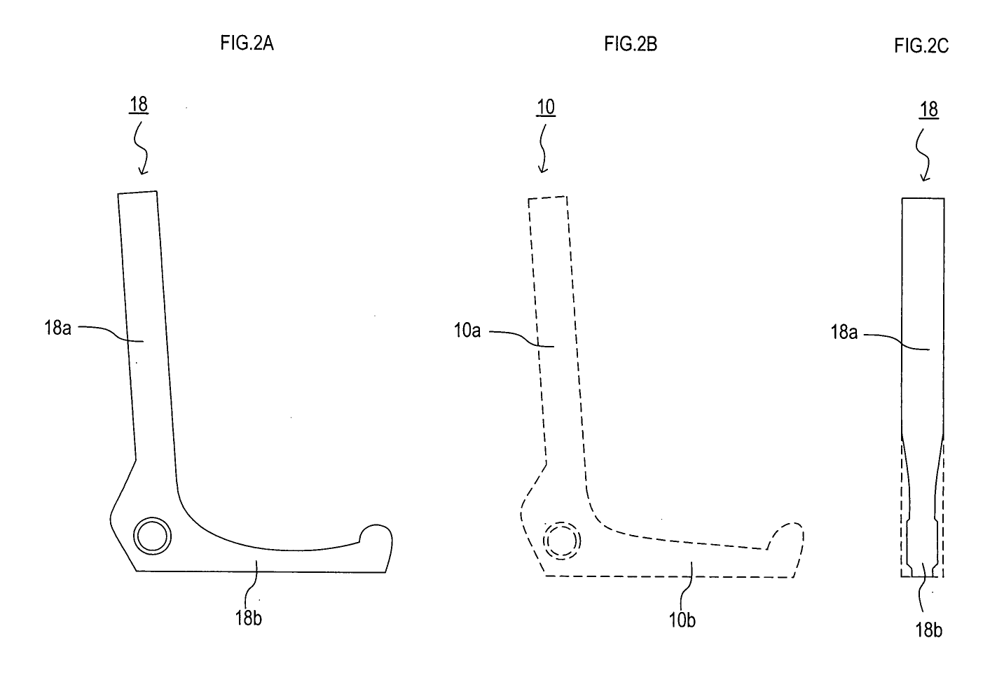

Now, the shape of the jack 18 is explained by referring to FIGS. 2A-2C. FIG. 2A is a view of the jack 18 in the present embodiment. FIG. 2B is a view of a conventionally used jack 10. FIG. 2C is a right side view of the jack 18. In FIG. 2C, the jack 10 is indicated by a dotted line.

The jack 10 is composed of an elongated big jack portion 10a and a small jack portion 10b. The big jack portion 10a is a portion extending in the vertical direction in FIG. 2B. The small jack portion 10b is a portion arranged almost perpendicular to the big jack portion 10a. Accordingly, the jack 10 is formed into a substantially L-shaped configuration.

The jack 18 is also shaped like an L-shape, comprising an elongated big jack portion 18a and a lightened small jack portion 18b arranged almost perpendicular to the big jack portion 18a. Specifically, the thickness of the lightened small jack portion 18b in a direction of key arrangement in a state of the jack 18 being fitted in the piano is thinner than the thickness of the big jack portion 18a.

As can be seen in FIG. 2C, there is no difference between the big jack portion 18a of the jack 18 and the big jack portion 10a of the jack 10. However, the thickness of the lightened small jack portion 18b is smaller than that of the small jack portion 10b. Accordingly, the overall weight of the jack 18 is less than that of the conventional jack 10. Specifically, the weight of the lightened small jack portion 18a is reduced. That is, the weight of the jack 18 is reduced by changing the shape of the lightened small jack portion 18b, without substantially changing the shape of the big jack portion 18a. Moreover, in the conventional jack 10, the upper side of the small jack portion 10b (that is, the side closer to the big jack portion 10a) has a linear shape. However, in the jack 18 of the present embodiment, the upper side of the lightened small jack portion 18b has a gently curved U-shape, resulting in a reduction of the width thereof (that is, the width in the vertical direction of the lightened small jack portion 18b in FIG. 2A). Thus, further decreasing the weight of the jack 18 is achieved (further lightening).

Returning to FIG. 1, when the jack 18 is fitted in the action mechanism 1, an adjustment member 30, which is a position adjustment mechanism of the jack 18, is attached to the big jack portion 18a. The adjustment member 30 is composed of a stop screw 31, a stop button 32, and a button felt 33. The button felt 33 abuts a top end portion of a spoon 40 provided on the wippen 15. By rotating the stop screw 31 the angle position of the jack 18 can be adjusted for a released key condition.

Now, the operation of the action mechanism 1 provided with the jack 18 is described.

When the player depresses a key 11 initially in a released state, the wippen 15 is pushed up to raise the repetition lever 16 and the jack 18. Along with the rising components, the repetition lever 16 slides under the shank roller 19a so as to push up the hammer shank 19b via the shank roller 19a. Subsequently, the repetition lever 16 abuts on the repetition screw 20a to stop the rise and swings. Then, the jack 18, initially moving upward together with the repetition lever 16, is raised further so as to push up the shank roller 19a with the apex of the big jack portion 18a (which passes through the long hole 16a). When the free end of the lightened small jack portion 18b abuts on the regulating button 17, the jack 18, which has stopped rising, is rotated clockwise in FIG. 1 to separate the apex of the big jack portion 18a from the shank roller 19a. Then, the striking member 19, pushed up by the jack 18, is in a free rotating state and rotates clockwise so as to make the hammer head 19c strike the string 25.

In the meantime, when the player stops depressing and releases the key 11 and the key 11 returns to a position of about one third (⅓) from a fully depressed depth, the jack 18, from a state of having pushed up the shank roller 19a, begins to return to the reset direction (that is, the original position where the jack 18 had been located before the key depression) together with the repetition lever 16 due to the spring force of the repetition spring 15d. When the apex of the big jack portion 18a is moved to a position below the shank roller 19a, the next striking of the string can be performed regardless of whether the key 11 is actually completely returned to the original position. Accordingly, it becomes possible to strike the same key 11 repeatedly like a trill.

Along with the movement of the key 11 to the original position, the wippen 15, the repetition lever 16, and the jack 18, are also moved in directions opposite to the directions they moved in at the time when the key 11 was depressed, so as to return to their original positions.

In the action mechanism 1 of the present embodiment as described above, the lightened small jack portion 18b of the jack 18 is made thin and the weight of the same is reduced compared to a conventional jack.

Therefore, the rotational speed of the jack 18 can be increased when the spring force toward the reset direction is applied to the jack 18. Furthermore, the time required can be shortened for the jack 18 to return from a position where the jack 18 has pushed up the shank roller 19a to the push-up capable position (the position below the shank roller 19a). Accordingly, more frequent repetitive striking becomes possible within a predetermined period, resulting in achieving an improvement in the repeated striking performance of the piano.

Moreover, only the weight of the lightened small jack portion 18b, rather than the weight of the jack 18 as a whole, is trimmed. Therefore, sufficient strength for moving the striking member 19 is maintained while the repeated striking property of the piano is improved.

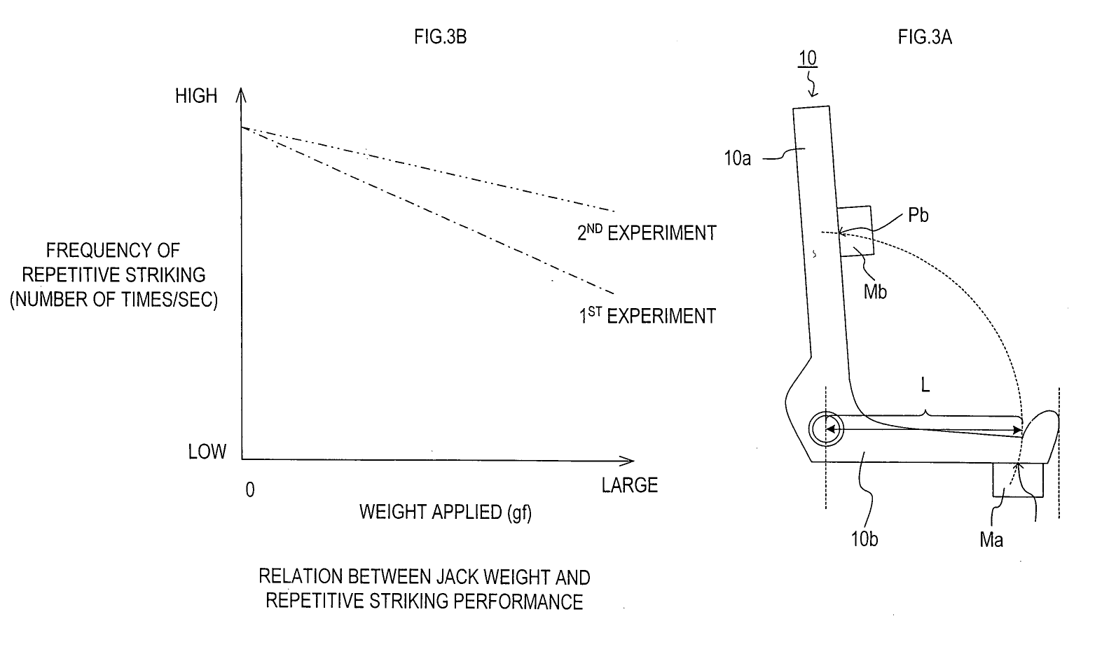

Experiments conducted to ascertain the above effects are now described referring to FIGS. 3A and 3B. FIG. 3A shows a jack used for the experiments which corresponds to the jack 10 shown in FIG. 2B. FIG. 3B is a graph showing the results of the experiments.

[First Experiment]

First of all, a distance L was made approximately seven eighth (⅞) of the distance between the rotational shaft of the jack 10 and the free end (end on the side opposite to the rotational shaft) of the small jack portion 10b. Also, as shown in FIG. 3A, a position Pa was made at a location on the small jack portion 10b, away from the rotational shaft by the distance L.

In a first experiment, the weight of a plummet Ma attached to position Pa was gradually increased, and the number of times of repetitive striking was measured.

[Second Experiment]

As shown in FIG. 3A, a position Pb was made at a location on the big jack portion 10a, away from the rotational shaft by the distance L.

In the second experiment, a plummet Mb was attached to the position Pb and the same measurements as in the first experiment were recorded.

[Results of Experiments]

FIG. 3B shows the results of the experiments. The vertical axis shows the number of times of repetitive striking. The horizontal axis shows the weight of load (the weight of the plummets Ma, Mb). The results of the first experiment are indicated by a single-dashed line and the results of the second experiment are indicated by a double-dashed line.

As seen in the results, the first experiment (that is, applying weight to the small jack portion 10b) shows a larger decrease in the repeated striking property with addition of weight as compared to the second experiment (that is, applying weight to the big jack portion 10a). Therefore, the effects produced on repetitive striking performance appear to be larger in the first experiment.

From the experiments above, it was found that in order to improve the repetitive striking performance, a reduction in weight of the small jack portion 10b of the jack 10 is more effective than a similar reduction in weight of the big jack portion 10a.

In the above description, an embodiment of the present invention has been detailed. However, the present invention is not limited to the above embodiment, and other modifications and variations may be possible.

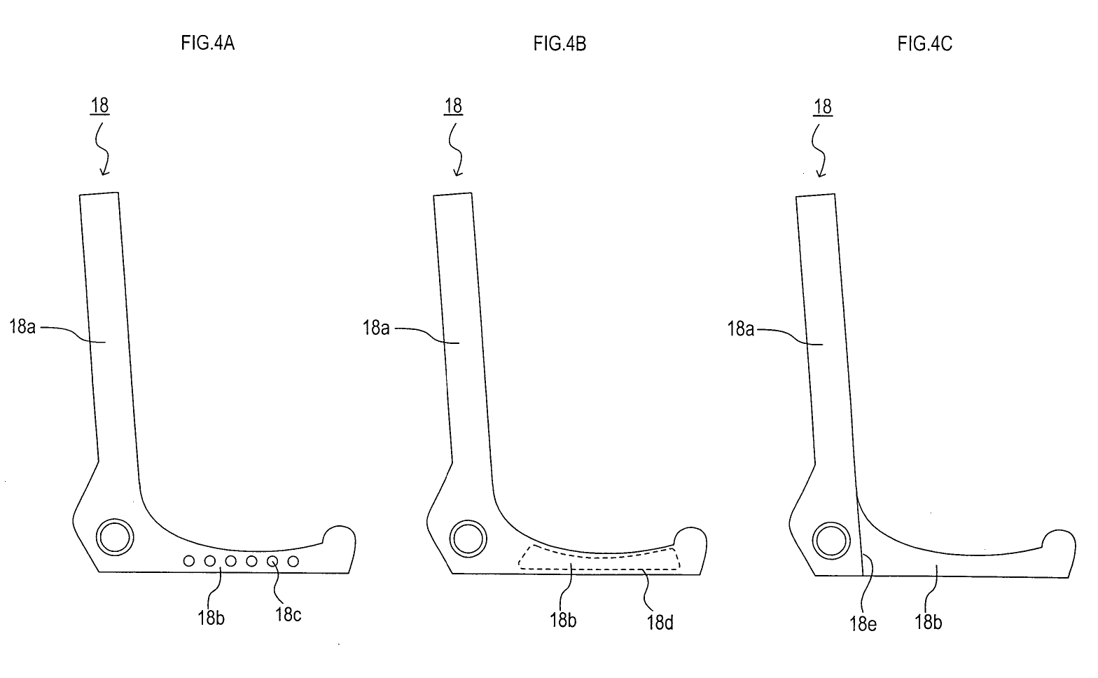

For instance, the shape of the jack 18 is not limited to the shape shown in FIG. 2A. The outer periphery of the lightened small jack portion 18b may be ground to reduce the weight or directly formed in the desired shape. Furthermore, the weight reduction may not be necessarily executed by changing the shape of the lightened small jack portion 18b. As shown in FIGS. 4A-4C, the lightened small jack portion 18b may be hollowed, contain holes 18c, cavities 18d, or voids, or use a material or combination of materials that is lighter than that of the big jack portion 18a. A line 18e in FIG. 4C is a boundary line between the big jack portion 18a and the lightened small jack portion 18b. The lightened small jack portion 18b may also be formed from a material with a higher strength to weight ratio than the material used in the big jack portion 18a. While polyacetal (specific gravity: 1.3) is used for the material of the big jack portion 18a, ABS resin (specific gravity: 1.1), for example, may be used for the small jack portion 18b. Other than ABS resin, polypropyrene (specific gravity: 0.9-1.0) or wood (specific gravity: 0.3-0.6) may be used for the small jack portion 18b. The aforementioned lightening techniques can be adapted to the small jack portion of an upright piano as well.

1. A method of improving repetitive striking performance of a piano comprising an action mechanism in which a substantially L-shaped jack pushes up a part of a striking member in response to key depression in order to make the striking member strike a string,
the jack being composed of elongated portions comprising:
a big jack portion for pushing up the striking member, and
a small jack portion integrated almost perpendicular to the big jack portion,
wherein the method comprises a step of lightening the small jack portion prior to assembly in the piano.

2. The method of improving repetitive striking performance of a piano as in claim 1, wherein the step of lightening the small jack portion comprises using a small jack portion with a thickness, in a direction of key arrangement in a state of the jack being fitted in the piano, less than a thickness of the big jack portion.

3. The method of improving repetitive striking performance of a piano as in claim 1, wherein the step of lightening the small jack portion comprises using a material less dense than a material used for forming the big jack portion.

4. The method of improving repetitive striking performance of a piano as in claim 1, wherein the step of lightening the small jack portion comprises incorporating voids into a material used for forming the big jack portion.

5. A jack for use in an action mechanism of a piano, that is formed into substantially an L-shape and pushes up a part of a striking member in response to key depression in order to make the striking member strike a string,
the jack being composed of:
an elongated big jack portion for pushing up the part of the striking member, and
a lightened small jack portion integrated almost perpendicular to the big jack portion.

6. The jack for use in an action mechanism of a piano as in claim 5, wherein the lightened small jack portion has a thickness, in a direction of key arrangement in a state of the jack being fitted in the piano, less than a thickness of the big jack portion.

7. The jack for use in an action mechanism of a piano as in claim 6, wherein the lightened small jack portion has an upper side formed in a gently curved concave shape.

8. The jack for use in an action mechanism of a piano as in claim 5, wherein the lightened small jack portion has an upper side formed in a gently curved concave shape.

9. The jack for use in an action mechanism of a piano as in claim 5, wherein the lightened small jack portion is formed from a material less dense than a material used to form the big jack portion.

10. The jack for use in an action mechanism of a piano as in claim 5, wherein the lightened small jack portion is formed from a material incorporating at least one void in the area of the lightened small jack portion.

11. The jack for use in an action mechanism of a piano as in claim 5, wherein the lightened small jack portion is formed from a material with a higher strength versus weight ratio than a material used for the big jack portion.

12. An action mechanism of a piano, comprising a substantially L-shaped jack that pushes up a part of a striking member in response to key depression in order to make the striking member strike a string,
the jack being composed of:
an elongated big jack portion for pushing up the part of the striking member, and
a lightened small jack portion integrated almost perpendicular to the big jack portion.

13. The action mechanism of a piano as in claim 12, wherein the lightened small jack portion has a thickness, in a direction of key arrangement in a state of the jack being fitted in the piano, less than a thickness of the big jack portion.

14. The action mechanism of a piano as in claim 13, wherein the lightened small jack portion has an upper side formed in a gently curved concave shape.

15. The action mechanism of a piano as in claim 12, wherein the lightened small jack portion has an upper side formed in a gently curved concave shape.

16. The action mechanism of a piano as in claim 12, wherein the lightened small jack portion is formed from a material less dense than a material used to form the big jack portion.

17. The action mechanism of a piano as in claim 12, wherein the lightened small jack portion is formed from a material incorporating at least one void in the area of the lightened small jack portion.

18. The action mechanism of a piano as in claim 12, wherein the lightened small jack portion is formed from a material with a higher strength versus weight ratio than a material used for the big jack portion.
